(19) United States
(12) Patent Application Publication
(10) Pub. No.: US 2026/0086851 A1
(43) Pub. Date: Mar. 26, 2026

(54) Electronic Control Device, Vehicle Control System, and Task Control Method

(71) Applicant: Hitachi Astemo, Ltd., Hitachinaka-shi, Ibaraki (JP)

(72) Inventors: Masashi MIZOGUCHI, Tokyo (JP); Tomohito EBINA, Hitachinaka-shi (JP); Koji MAEDA, Hitachinaka-shi (JP); Tasuku ISHIGOOKA, Hitachinaka-shi (JP); Kentaro YOSHIMURA, Tokyo (JP)

(21) Appl. No.: 19/111,835

(22) PCT Filed: Apr. 4, 2023
(86) PCT No.: PCT/JP2023/013937

§ 371 Date: Mar. 14, 2025

(30) Foreign Application Priority Data
Sep. 27, 2022 (JP) 2022-153400

(51) Int. Cl. G06F 9/48

(52) U.S. Cl. CPC G06F 9/4887

(57) ABSTRACT

Provided is an electronic control device, in which a timeslot allocation unit receives an input of data flow request information and timeslot request information, the data flow request information including information on a task for generating data to be input to the new task and information on how many periods before a timeslot for activating the new task to use the data generated by the task and the timeslot request information including information on a number of timeslots necessary for executing the new task, searches for an empty timeslot in which the new task is executed based on the timeslot allocation information, the data flow request information, and the timeslot request information, and updates the timeslot allocation information so as to allocate the new task to the searched empty timeslot.

### INCORPORATION BY REFERENCE

The present application claims priority to Japanese Patent Application No. 2022-153400 filed on Sep. 27, 2022, the contents of which are incorporated herein by reference.

### TECHNICAL FIELD

The present invention relates to an electronic control device and a vehicle control system.

### BACKGROUND ART

Continuous improvement of vehicle control software is required with advancement and complication of vehicle control such as automatic driving. The vehicle control software is required to have a real-time property, and each task needs to complete processing by a predetermined deadline. However, when task scheduling is performed every time the vehicle control software is changed, a cost is required for the design and verification, which is a bottleneck in continuous improvement of the vehicle control software.

As a task scheduling technique, there is a technique described in Japanese Patent Application Laid-Open No. 2012-181852 (PTL 1). This publication addresses the problem of providing a method for scheduling the processing of a task that can effectively use resources, particularly suitable for use in the field of on-board electronics, and describes, as a solution thereof, that the processing of the task includes a step of setting resources necessary for the execution of the task, and a step of executing the task on the set resources, and in the scheduling, includes a step of selecting at least one task level to be processed, and a step of determining the number of resources necessary for the processing of the task and a priority order of the processing of the task according to a characteristic time of the task by sorting the tasks based on the task level to be processed according to the priority order.

Furthermore, according to JP 2009-80820 A (PTL 2), an object thereof is to provide a task switching device that facilitates program design that specifies priority for satisfying required performance of each task and has flexibility in program design, and as a means for solving the problem, the task switching device switches execution of a task allocated to a timeslot by switching timeslots in a processor, the task switching device includes: a timeslot information storage means that stores an allocation time of each of a plurality of tasks of a first type that have a pointer for associating a task with a timeslot and designation of an allocation time; a task storage means that stores priority of each of a plurality of tasks of a second type that have priority; n allocation means that allocates each of the plurality of tasks of the first type to one of the plurality of timeslots in one period in a one-task-to-one-timeslot manner based on the pointer to allocate the plurality of tasks of the second type to one specific timeslot which is not allocated with a task of the first type in a multitask-to-one timeslot manner based on the point; a timeslot switching means that switches a timeslot based on an allocation time designated to each of the plurality of tasks stored in the timeslot information storage means; and a task selection means that selects a task allocated to the timeslot in a case where switching is made to a timeslot other than the specific timeslot, and selects one task based on the priority stored in the task storage means from the plurality of tasks of the second type in a case where switching is made to the specific timeslot.

### SUMMARY OF INVENTION

### Technical Problem

According to PTL 1, resources can be efficiently used by sorting tasks and allocating resources based on a resource amount of a central processing unit (CPU) necessary for execution of each task and a characteristic value calculated by a remaining time or a priority group. However, since the timing at which each task is processed by the CPU varies due to sorting, there is a possibility that the processing timing of each task varies in a case where the vehicle control software is updated. This may affect data communication between tasks and communication with the outside of an electronic control device (electronic control unit (ECU). Therefore, it is necessary to verify that the communication is not affected by the change of the vehicle control software.

According to PTL 2, priority design is facilitated by dividing timeslots into two types, allocating tasks on a one-to-one manner to a first timeslot, and allocating tasks on a many-to-one manner to a second timeslot. However, particularly in the second timeslot, there is a possibility that scheduling changes due to a change in vehicle control software, and verification is required as in PTL 1.

In view of the above, an object of the present invention is to make the scheduling design and verification of a real-time task at the time of changing the vehicle control software unnecessary as much as possible, and it is an object of the present invention to provide scheduling of a task that can ensure that a processing result does not change with respect to an existing task before and after the change of the vehicle control software.

### Solution to Problem

In order to solve the above-described problems, a representative example of the invention disclosed in the present application is as follows. That is, an electronic control device including: an arithmetic device that performs predetermined arithmetic processing and periodically executes a task; and a memory device that can be accessed by the arithmetic device. Timings of data input and data output of the task are determined in advance. The electronic control device comprises: a timeslot allocation information storage unit that stores timeslot allocation information defining an execution timing of the task between the predetermined data input timing and data output timing; a task activation unit that activates the task according to the timeslot allocation information; and a timeslot allocation unit that stores information of a new task in the timeslot allocation information storage unit according to an execution timing of the new task. The timeslot allocation unit is configured to execute: receiving an input of data flow request information and timeslot request information, the data flow request information including information on a task for generating data to be input to the new task and information on how many periods before a timeslot for activating the new task to use the data generated by the task and the timeslot request information including information on a number of timeslots necessary for executing the new task; searching for an empty timeslot in which the new task is executed based on the timeslot allocation information, the data flow request information, and the timeslot request information; and updating the timeslot allocation information so as to allocate the new task to the searched empty timeslot.

### Advantageous Effects of Invention

According to one aspect of the present invention, timing design and verification are unnecessary even when a new task is added to an electronic control device, and continuous improvement of vehicle control software can be realized. Objects, configurations, and effects besides the above description will be apparent through the explanation on the following embodiments.

### BRIEF DESCRIPTION OF DRAWINGS

FIG. 1 is a diagram illustrating a hardware configuration of an electronic control device according to a first embodiment.

FIG. 2 is a diagram illustrating a software configuration of the electronic control device according to the first embodiment.

FIG. 3 is a diagram illustrating a configuration of middleware of the first embodiment.

FIG. 4 is a diagram illustrating timeslot allocation information according to the first embodiment.

FIG. 5 is a diagram illustrating update of information stored in a timeslot allocation information storage unit according to the first embodiment.

FIG. 6 is a diagram illustrating data flow request information according to the first embodiment.

FIG. 7 is a diagram illustrating update of information stored in a data flow request information storage unit according to the first embodiment.

FIG. 8 is a diagram illustrating an outline of functions of a communication API providing unit according to the first embodiment.

FIG. 9 is a diagram illustrating timeslot request information according to the first embodiment.

FIG. 10 is a flowchart illustrating a method for searching for a timeslot by a timeslot allocation unit according to the first embodiment.

FIG. 11 is a diagram illustrating timeslot request information of a new task (fourth task) of a second embodiment.

FIG. 12 is a diagram illustrating update of timeslot allocation information and data flow request information according to the second embodiment.

FIG. 13 is a diagram illustrating a hardware configuration of a vehicle control system according to a third embodiment.

FIG. 14 is a diagram illustrating software configurations of a first electronic control device and a second electronic control device according to the third embodiment.

FIG. 15 is a diagram illustrating configurations of middleware of the first electronic control device and the second electronic control device according to the third embodiment.

FIG. 16 is a diagram illustrating timeslot allocation information (before addition of a new task) according to the third embodiment.

FIG. 17 is a diagram illustrating data flow request information (before addition of a new task) according to the third embodiment.

FIG. 18A is a diagram illustrating data flow request information regarding a new task (fourth task) of the third embodiment.

FIG. 18B is a diagram illustrating timeslot request information regarding a new task (fourth task) of the third embodiment.

FIG. 19 is a flowchart of timeslot search processing by a timeslot allocation unit according to the third embodiment.

FIG. 20 is a diagram illustrating timeslot allocation information (after addition of a new task) according to the third embodiment.

FIG. 21 is a diagram illustrating updating of timeslot allocation information and data flow request information according to a fifth embodiment.

FIG. 22 is a diagram illustrating update of timeslot allocation information and data flow request information according to a sixth embodiment.

FIG. 23 is a diagram illustrating a hardware configuration of a vehicle control system according to an eighth embodiment.

FIG. 24 is a diagram illustrating a software configuration of a vehicle control system according to the eighth embodiment.

FIG. 25 is a diagram illustrating a software configuration of a vehicle control system according to a ninth embodiment.

### DESCRIPTION OF EMBODIMENTS

The present invention relates to an electronic control device (ECU) and a vehicle control system.

Hereinafter, embodiments according to the present invention will be described. In the embodiments of the present invention, for the sake of simplicity, an example in which the electronic control device has one CPU and is equipped with a real-time operating system (OS) will be described. However, by multiplexing timeslot allocation information based on the number of equipped cores and the number of threads, the present invention can be easily applied to an ECU equipped with a multi-core CPU, POSIX which is a non-real-time OS, and the like.

### First Embodiment

### <Configuration>

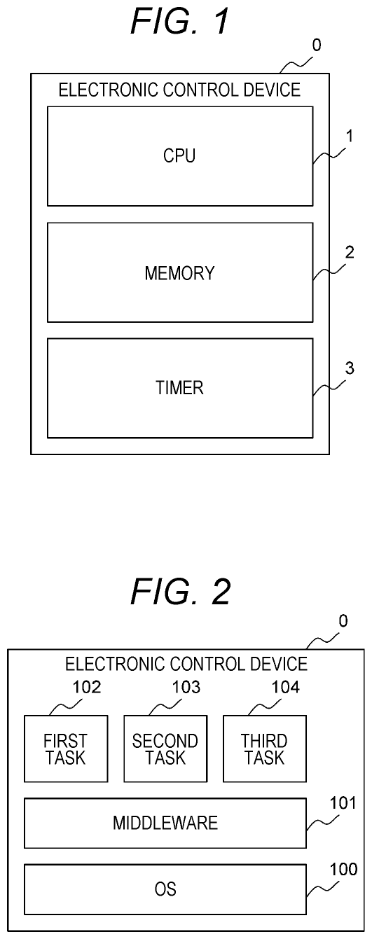

FIG. 1 is a diagram illustrating a hardware configuration of an electronic control device 0 of a first embodiment, and FIG. 2 is a diagram illustrating a software configuration of the electronic control device 0 of the present embodiment.

### <Electronic Control Device 0>

A hardware configuration of the electronic control device 0 according to the present embodiment will be described with reference to FIG. 1. The electronic control device 0 includes a CPU 1, a memory 2, and a timer 3. The memory 2 stores information such as a code and a parameter of a task. The data stored in the memory 2 is transferred to the CPU 1, arithmetic processing is performed, and an arithmetic processing result is stored in the memory 2. The timer 3 is used to acquire time inside the electronic control device 0. In the present embodiment, the timer 3 has a function of notifying the CPU 1 of the time every 10 milliseconds.

A software configuration of the electronic control device 0 according to the present embodiment will be described with reference to FIG. 2. The software is stored in the memory 2 of the electronic control device 0 and executed by the CPU 1. The electronic control device 0 includes an operating system (OS) 100, middleware 101, and a first task 102, a second task 103, and a third task 104 as applications. The OS 100 may be a general real-time OS or an OS such as POSIX. The middleware 101 is activated from the OS 100, and activates the first task 102, the second task 103, and the third task 104 which are applications. That is, the application is not directly activated from the OS 100, but is activated by the middleware 101. Furthermore, data communication between applications is performed via the middleware 101. That is, it is prohibited to arrange the shared memory in the application itself, and all data communication between the applications is performed using an application programming interface (API) provided by the middleware 101.

### <Middleware 101>

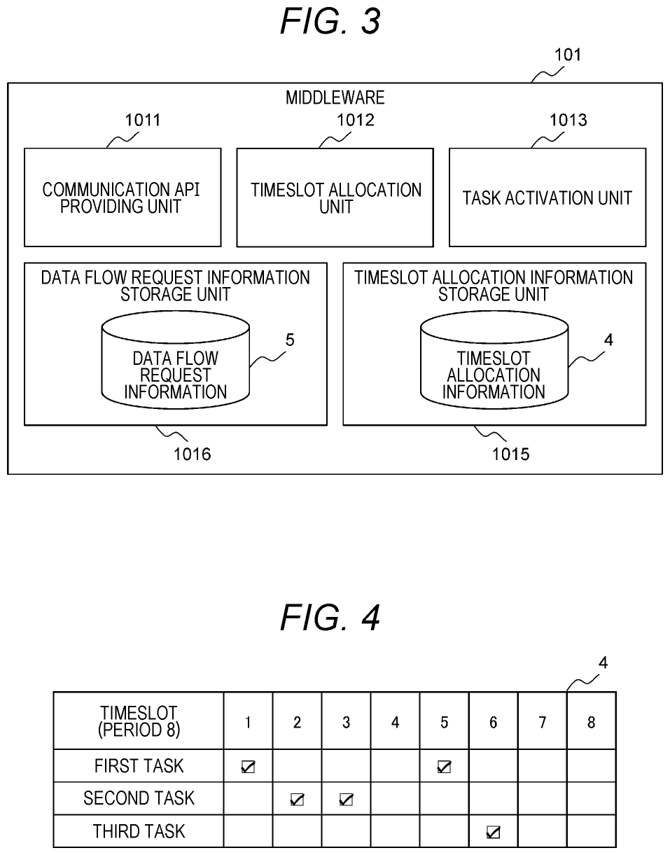

FIG. 3 is a diagram illustrating a configuration of the middleware 101 of the present embodiment.

In the present embodiment, the middleware 101 includes a communication API providing unit 1011, a timeslot allocation unit 1012, a task activation unit 1013, a timeslot allocation information storage unit 1015, and a data flow request information storage unit 1016. The function and operation of each unit will be described later.

### <Timeslot Allocation Information 4, Task Activation Unit 1013>

FIG. 4 is a diagram illustrating timeslot allocation information 4 of the present embodiment.

The timeslot allocation information 4 describes the allocation of task and timeslot. Although FIG. 4 illustrates the timeslot allocation information 4 described in a table format, the timeslot allocation information 4 may be indicated in another format. The task activation by the task activation unit 1013 using the timeslot allocation information 4 will be described with reference to FIG. 4. The timer 3 notifies the task activation unit 1013 of the time via the OS 100. When the first time is notified from the timer 3, the task activation unit 1013 searches for the first timeslot in the timeslot allocation information 4 and activates the allocated first task 102. After 10 milliseconds, when the second time is notified from the timer 3, the task activation unit 1013 searches for the second timeslot in the timeslot allocation information 4 and activates the allocated second task 103. After 10 milliseconds, when the third time is notified from the timer 3, the task activation unit 1013 searches for the third timeslot in the timeslot allocation information 4. At this time, the second task 103 is allocated, but the task 2 has been activated in the second timeslot and is continuously allocated to the third timeslot, so that the task activation unit 1013 continues the processing of the second task 103. In a case where the processing of the second task 103 is completed in the second timeslot, the task activation unit 1013 does not activate any task in the third timeslot (that is, the second task 103 is not newly activated). After 10 milliseconds, when the fourth time is notified from the timer 3, the task activation unit 1013 searches for the fourth timeslot in the timeslot allocation information 4. Since no task is allocated this time, the task activation unit 1013 does not activate any task. In this way, the task activation unit 1013 selects which task is to be activated in each timeslot. In FIG. 4, eight timeslots are shown, indicating that the activation of the task is repeated in eight periods. That is, when the middleware 101 is notified of the ninth time from the timer 3, the task activation unit 1013 searches for the first timeslot similarly to the time of the first time notification. Hereinafter, such a period of the timeslot allocation information 4 is referred to as a hyperperiod. Although the hyperperiod is 8 in FIG. 4, any non-negative integer may be used.

### <Timeslot Allocation Information Storage Unit 1015>

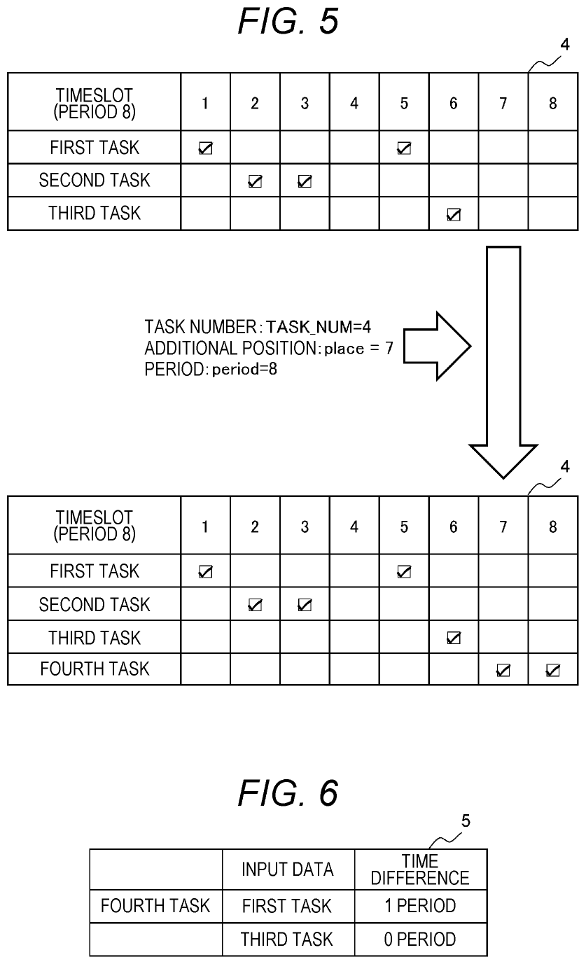

FIG. 5 is a diagram illustrating update of the timeslot allocation information 4 stored in the timeslot allocation information storage unit 1015 of the present embodiment.

When instructed to update the timeslot allocation information 4 from the timeslot allocation unit 1012, the timeslot allocation information storage unit 1015 adds the new task to the timeslot allocation information 4 according to the input number (ID: Identifier) of the new task and information (data flow request information 5, timeslot request information 6) of the allocation position and period, and updates the timeslot allocation information 4 stored in the timeslot allocation information storage unit 1015.

### <Data Flow Request Information 5>

FIG. 6 is a diagram illustrating data flow request information 5 of the present embodiment.

The data flow request information 5 is information transmitted from the outside of the electronic control device 0 to the middleware 101. As illustrated in FIG. 5, it is defined in the data flow request information 5 that a fourth task 105 added to the electronic control device 0 uses the processing results of the first task 102 and the third task 104. In the present embodiment, since all the tasks are tasks that are periodically executed, it is necessary to consider at which time point the processing result generated by the first task 102 and the third task 104 is used by the fourth task 105. Therefore, the data flow request information 5 includes information on the time difference. The time difference is information indicating how many periods before each of the input data generation tasks (the first task 102 and the third task 104) from the timeslot in which the new task (the fourth task 105) is activated is used as the input data of the new task (the fourth task 105).

### <Data Flow Request Information Storage Unit 1016>

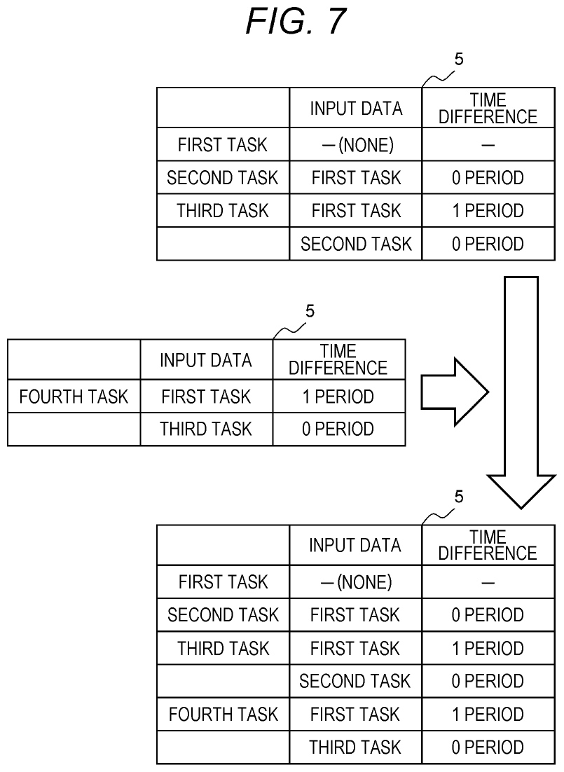

FIG. 7 is a diagram illustrating update of the data flow request information 5 stored in the data flow request information storage unit 1016.

When instructed to store the new task from the timeslot allocation unit 1012, the data flow request information storage unit 1016 newly adds the data flow request information 5 related to the fourth task 105 according to the data flow request information 5 related to the fourth task 105 which is the input new task, and updates the data flow request information storage unit 1016.

### <Communication API Providing Unit 1011>

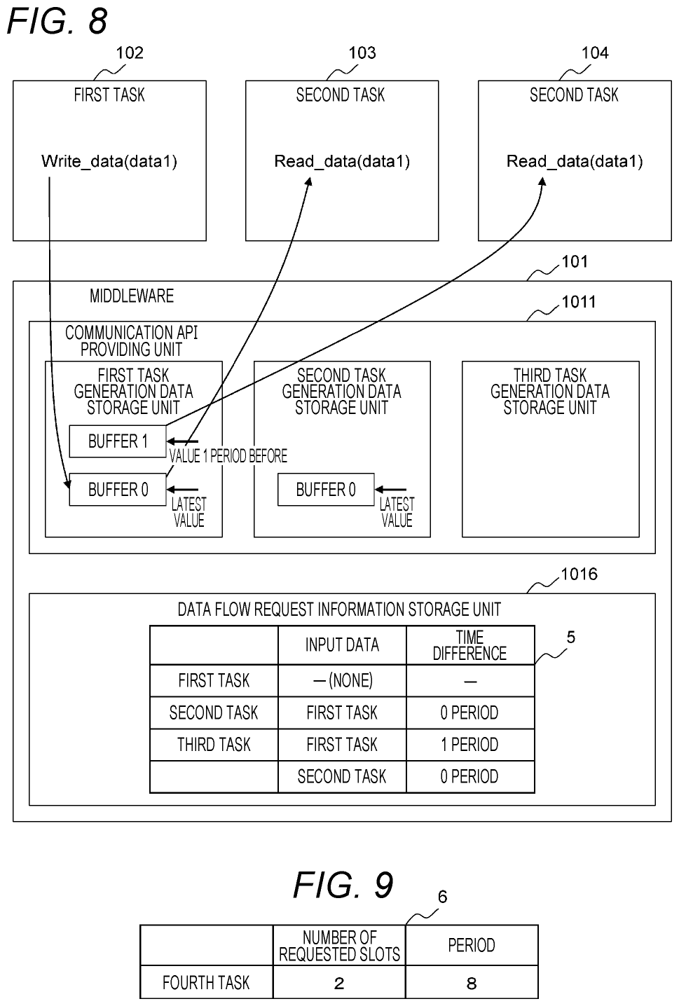

FIG. 8 is a diagram illustrating an outline of functions of the communication API providing unit 1011.

The communication API providing unit 1011 has a role of managing data shared between tasks and providing the data according to a call from the task. At this time, the communication API providing unit 1011 refers to the data flow request information 5 and provides data generated at an appropriate time. The first task 102 calls Write_data which is an API provided by the communication API providing unit 1011 in order to provide a processing result to another task (the second task 103 and the third task 104). The data flow request information 5 stored in the data flow request information storage unit 1016 indicates that the communication data generated by the first task 102 is used with a delay of 0 period in the second task 103 and is used with a delay of 1 period in the third task 104. Therefore, the communication API providing unit 1011 is provided with a first task generation data storage unit, and stores data generated most recently by the first task 102 and data generated 1 period before the data. For example, in FIG. 8, the latest value is stored in a buffer 0, and the value of 1 period before is stored in a buffer 1. That is, when the first task 102 calls Write_data, the communication API providing unit 1011 copies the data stored in the buffer 0 of the first task generation data storage unit to the buffer 1, and then writes the data in the buffer 0. The second task 103 calls Read_data to use data generated by the first task 102. At this time, since it can be seen by referring to the data flow request information 5 that the second task 103 uses the generation data of the first task 102 at the time difference of 0 period, the communication API providing unit 1011 copies the data stored in the buffer 0 of the first task generation data storage unit and passes the data to the second task 103. Similarly, the third task 104 calls Read_data to use data generated by the first task 102. At this time, since it can be seen by referring to the data flow request information 5 that the second task 103 uses the generation data of the first task 102 at the time difference of 1 period, the communication API providing unit 1011 copies the data stored in the buffer 1 of the first task generation data storage unit and passes the data to the third task 104. As can be seen from this, the number of buffers provided in the generation data storage unit of each task is determined by the maximum value of the time difference included in the data flow request information 5. By executing all data communication between tasks via the communication API providing unit 1011, each task can acquire and disclose data so as to satisfy the data flow request information 5.

### <Timeslot Request Information 6>

FIG. 9 is a diagram illustrating the timeslot request information 6 of the present embodiment.

The timeslot request information 6 is information transmitted from the outside of the electronic control device 0 to the middleware 101. The timeslot request information 6 indicates the period of the task and how many timeslots are requested to be allocated to the middleware 101 for one processing of the task. In the timeslot request information 6 illustrated in FIG. 5, the fourth task 105 is executed in a period of eight timeslots (that is, 80 milliseconds), and requests two timeslots. This is to request a processing time of 20 milliseconds of the CPU 1 for one processing of the fourth task 105. Note that, in a case where all the periods of the task are hyperperiods, information on the periods may be omitted in the timeslot request information 6.

### <Timeslot Allocation Unit 1012>

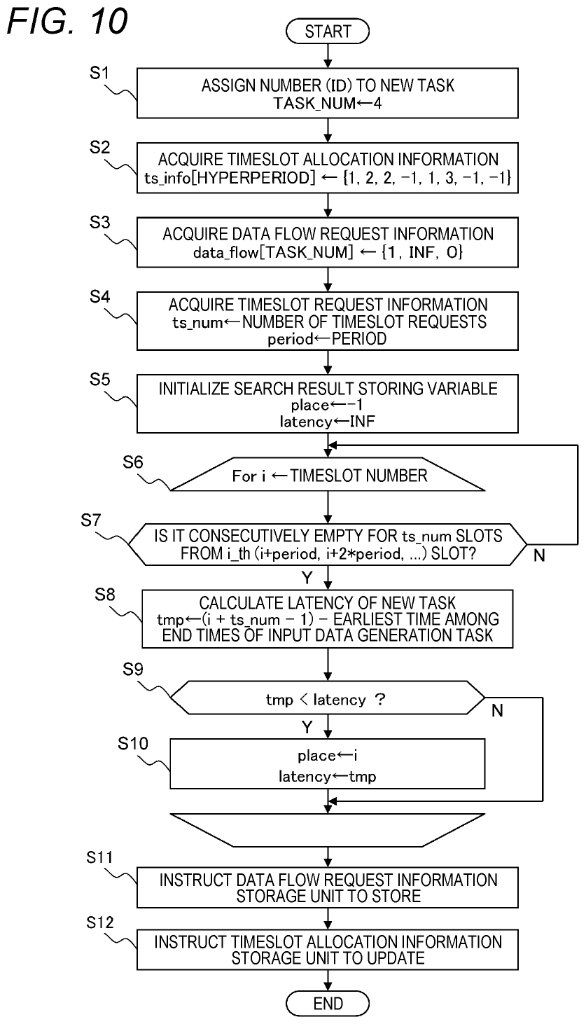

FIG. 10 is a flowchart illustrating a method for searching for a timeslot by the timeslot allocation unit 1012 according to the present embodiment.

In the present embodiment, the fourth task 105 is newly added to the electronic control device 0 on which the first task 102, the second task 103, and the third task 104 are mounted.

In step S1, a number (ID) is assigned to a newly added task. In step S2, the timeslot allocation information 4 is acquired. That is, according to the timeslot allocation information 4 illustrated in FIG. 4, {1, 2, 2, −1,1, 3, −1, −1} is sequentially substituted into an array ts_info (the number of elements is 8 because it coincides with the hyperperiod) for storing the timeslot allocation information 4. Note that −1 indicates an empty timeslot to which no task is allocated. Subsequently, in step S3, the data flow request information 5 is stored in the array data_dlow. In accordance with the data flow request information 5 illustrated in FIG. 6, {1, −1, 0} is sequentially substituted into data_flow. The first element indicates that the time difference of the first task 102 is 1 period, and the third element indicates that the time difference of the third task 104 is 0 period. Substituting −1 in the second element indicates that the second task 103 is not the input data generation task. In step S4, the number of requested slots and the period included in the timeslot request information 6 are stored in variables ts_num and period, respectively. In step S5, a search result storing variable is initialized. A variable place indicates a timeslot number for activating the new task (fourth task 105), and a variable latency is for storing a time from the completion of generation of input data to the new task (fourth task 105) to the completion of processing of the new task (fourth task 105), that is, a latency by the new task (fourth task 105).

In step S6, timeslot numbers 1 to 8 are sequentially substituted into a repetitive variable i, and the processes in steps S7 to S10 are repeatedly executed. The process in step S6 may be implemented by a For statement. In step S7, with reference to the array ts_info, it is determined whether there is an empty timeslot corresponding to ts_num slots consecutively from the i_th timeslot. Similarly, it is similarly determined whether there is an empty timeslot corresponding to ts num slots consecutively from the (i+period)_th timeslot, or the (i+2*period)_th, the (i+3*period)_th, . . . , and the (i+(n−1)*period)_th timeslot. Here, n is a number obtained by dividing a hyperperiod by a period. As a result of the determination, in a case where there is an empty timeslot, the process proceeds to step S8. On the other hand, in a case where there is no empty timeslot, since the new task (fourth task 105) cannot be added to the i_th timeslot, the process returns to step S6, the variable i is incremented, and the process proceeds to step S7 again. In step S8, the latency of the new task (fourth task 105) in a case where the new task (fourth task 105) is added to the i_th timeslot is calculated and stored in a temporary variable tmp. The latency refers to the array data_flow in which the data flow request information 5 is stored, and is a time from the time when the timeslot allocated to the new task (fourth task 105) ends to a time when the timeslot allocated to the task that generates the input data of the new task (fourth task 105) ends. In a case where there is a plurality of input data generation tasks, the latency may be calculated at the end time of the input data generation task farthest from the i_th timeslot. For example, in the timeslot allocation information 4 illustrated in FIG. 4, in the case of the i_th (i=7) timeslot, since the time at which the first task 102 which is the input data generation task ends is data_flow [0]=1, the first timeslot is referred to instead of the fifth timeslot in which the first task 102 is executed, and the latency is calculated to be 7 from the end of the first task 102 to the eighth timeslot which is the timeslot at which the new task (fourth task 105) ends. For the third task 104, since data_flow [2]=0, the period from the sixth timeslot in which the third task 104 is executed to the eighth timeslot in which the new task (fourth task 105) ends is counted, and the latency is calculated to be 2. Therefore, since the maximum value of the latency is 7, tmp=7 is calculated. In step S9, it is checked whether the value of tmp is smaller than the value of latency. If the value of tmp is smaller than the value of latency, the process proceeds to step S10, and place and latency are updated with the values of i and tmp. If the value of tmp is not smaller than the value of latency, there is a timeslot position where the latency can be shorter than that of the i_th timeslot. Therefore, the process returns to step S6, the variable i is incremented, and the process proceeds to step S7 again.

When the repetitive processes in steps S6 to S10 end, in step S11, the data flow request information 5 of the new task (fourth task 105) is instructed to be stored in the data flow request information storage unit 1016. Then, in step S12, the information of the task number (ID) TASK_NUM, the additional timeslot position place, and the period period included in the timeslot request information 6 determined in steps S1 to S10 is passed to the timeslot allocation information storage unit 1015, and the update of the timeslot allocation information 4 is instructed.

According to the present embodiment, even when a new task is added to the electronic control device 0, the new task does not affect a timeslot already allocated for execution of an existing task. Therefore, even after the addition of the new task, a data flow between the tasks is also maintained, and the real-time property of the task is maintained. Therefore, it is guaranteed that data communication between tasks and communication with the outside of the electronic control device are not affected, and timing design and verification, which have been bottlenecks, are unnecessary, and continuous improvement of vehicle control software can be realized. In addition, the Logical Execution Time, which is a scheduling method for limiting data exchange between tasks to a predetermined timing by the communication API providing unit 1011 and the task activation unit 1013, can be applied, and the data flow defined in the data flow request information 5 can be achieved after the variation in the processing time of each task is absorbed. Further, it is possible to newly add a task so as to minimize latency while ensuring that an existing task is not affected.

### Second Embodiment

An electronic control device according to a second embodiment of the present invention will be described. The second embodiment is different from the first embodiment in that consecutive empty timeslots are increased by changing timeslot allocation of an existing task. In the second embodiment, differences from the first embodiment will be mainly described, and the same components as those of the first embodiment are denoted by the same reference numerals, and description thereof will be omitted.

### <Timeslot Request Information>

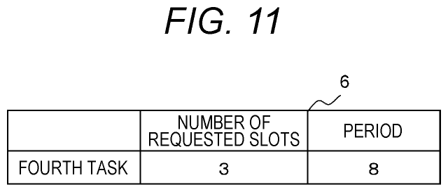

FIG. 11 is a diagram illustrating timeslot request information 6 of the new task (fourth task 105) of the present embodiment.

Similarly to the first embodiment, the timeslot request information 6 is information transmitted from the outside of the electronic control device 0 to the middleware 101. In the timeslot request information 6 illustrated in FIG. 11, the fourth task 105 is executed in a period of 8 timeslots (that is, 80 milliseconds), and requests three timeslots.

### <Timeslot Allocation Unit 1012, Timeslot Allocation Information Storage Unit 1015, and Data Flow Request Information Storage Unit 1016>

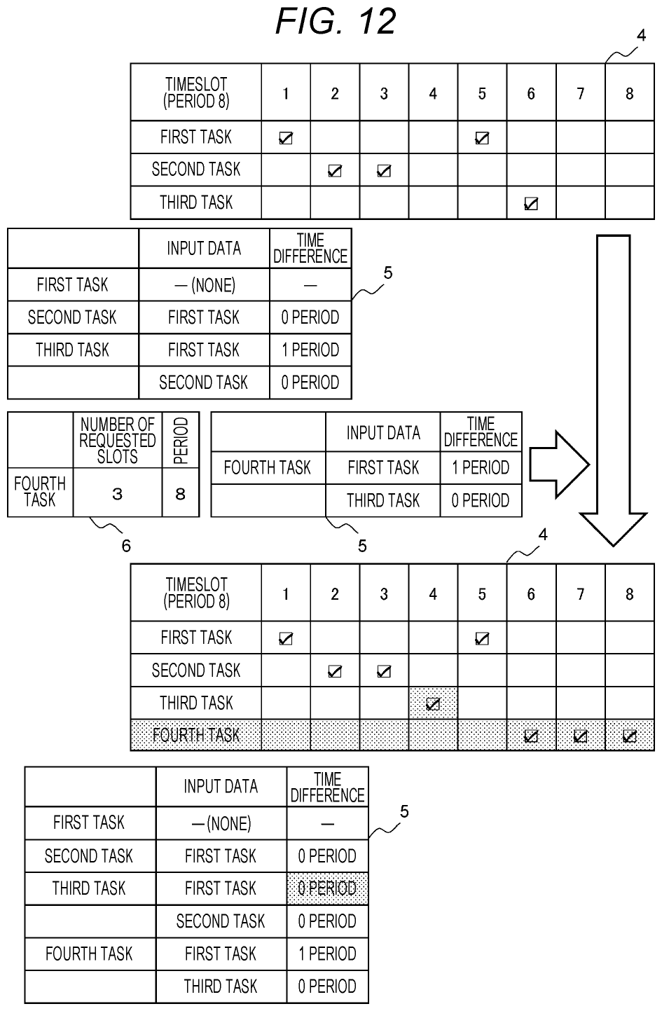

FIG. 12 is a diagram illustrating update of the timeslot allocation information 4 and the data flow request information 5 of the present embodiment.

The timeslot allocation unit 1012 searches for an empty timeslot according to the algorithm illustrated in FIG. 10. In the case of the present embodiment, since the number of requested timeslots is three, an empty timeslot is not found and the search fails. Therefore, the timeslot allocation unit 1012 analyzes the data flow request information 5 and searches for a process that can be moved forward. As a result, it can be seen that the third task 104 can be moved forward. Before the addition of the new task (fourth task 105), the third task 104 is executed in the sixth timeslot, and according to the data flow request information 5, it can be seen that the processing result executed in the first timeslot and the processing results executed in the second and third timeslots are used. Therefore, since the third task 104 can be executed in the fourth and subsequent timeslots, the execution timing of the third task 104 is moved from the sixth timeslot to the fourth timeslot. At this time, since the third task 104 continues to use the execution result of the first task 102 in the first timeslot in order not to change the data flow, the time difference of the third task 104 from the first task 102 in the data flow request information 5 is updated from 1 period to 0 period. Then, the timeslot allocation unit 1012 allocates the execution of the new task (fourth task 105) to the sixth, seventh, and eighth timeslots, updates the timeslot allocation information 4 and the data flow request information 5, and instructs the timeslot allocation information storage unit 1015 and the data flow request information storage unit 1016 to update and store the data.

According to the present embodiment, in a case where a new task is added in a situation where a sufficient free time cannot be secured due to a task already executed by the electronic control device 0, the free time can be increased while maintaining the data flow of the existing task, and the new task can be added.

### Third Embodiment

An electronic control device and a vehicle control system according to a third embodiment of the present invention will be described. The third embodiment is different from the first embodiment in that a search for an empty timeslot is performed between a plurality of electronic control devices. In the third embodiment, differences from the first embodiment will be mainly described, and the same components as those of the first embodiment are denoted by the same reference numerals, and description thereof will be omitted.

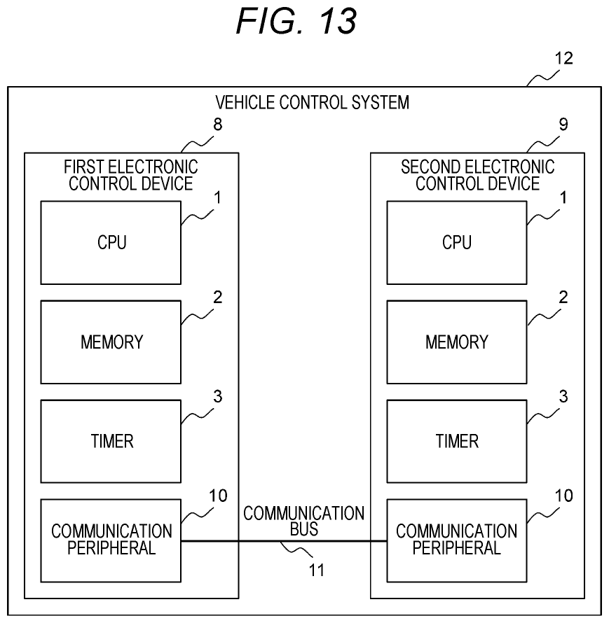

FIG. 13 is a diagram illustrating a hardware configuration of a vehicle control system 12 according to the present embodiment.

### <Vehicle Control System 12>

The vehicle control system 12 includes two electronic control devices, a first electronic control device 8 and a second electronic control device 9, which are connected to each other by a communication bus 11 and communicate with each other. In the present embodiment, two electronic control devices are provided, but three or more electronic control devices may be provided. The communication bus 11 transfers data according to a known communication protocol such as a controller area network (CAN) or Ethernet. The first electronic control device 0 and the second electronic control device 9 have a communication peripheral 10 which is hardware for performing communication via the communication bus 11. The communication peripheral 10 is hardware that controls communication, and specifically, is known hardware called a CAN transceiver in a case where the communication bus 11 is CAN, and called Ethernet PHY in a case where the communication bus is Ethernet.

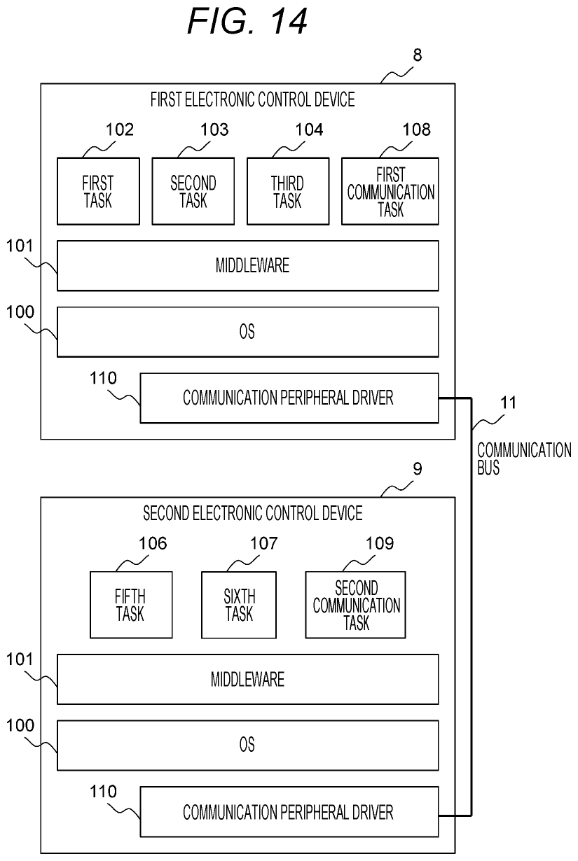

FIG. 14 is a diagram illustrating software configurations of the first electronic control device 8 and the second electronic control device 9 according to the present embodiment.

### <Software Configuration of First Electronic Control Device 8>

The first electronic control device 8 includes a first task 102, a second task 103, a third task 104, middleware 101, an OS 100, a communication peripheral driver 110, and a first communication task 108. The communication peripheral driver 110 is software for driving the communication peripheral 10, is called by the OS 100 or the middleware 101, and provides a function of accessing the communication peripheral 10 and writing data to be transmitted to a predetermined register of the communication peripheral 10 and a function of reading data from a predetermined register of the received communication peripheral 10. The first communication task 108 is a task for performing data communication in the first electronic control device 8, and details thereof will be described later.

### <Software Configuration of Second Electronic Control Device 9>

The second electronic control device 9 has a fifth task 106, a sixth task 107, middleware 101, an OS 100, a communication peripheral driver 110, and a second communication task 109. The second communication task 109 is a task for performing data communication in the second electronic control device 9, and details thereof will be described later.

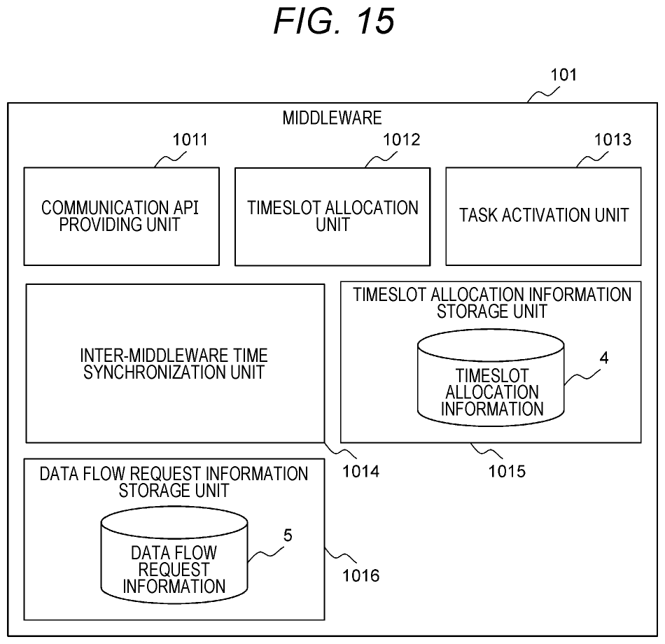

FIG. 15 is a diagram illustrating the configuration of the middleware 101 of the first electronic control device 8 and the second electronic control device 9 of the present embodiment.

### <Middleware 101>

The middleware 101 includes a communication API providing unit 1011, a timeslot allocation unit 1012, a task activation unit 1013, a timeslot allocation information storage unit 1015, a data flow request information storage unit 1016, and an inter-middleware time synchronization unit 1014. The inter-middleware time synchronization unit 1014 is included in the vehicle control system 12 and has a function of synchronizing time among the middleware 101 mounted on the electronic control device connected to each other via the communication bus 11. For the time synchronization, a known method such as a network time protocol (NTP) can be employed.

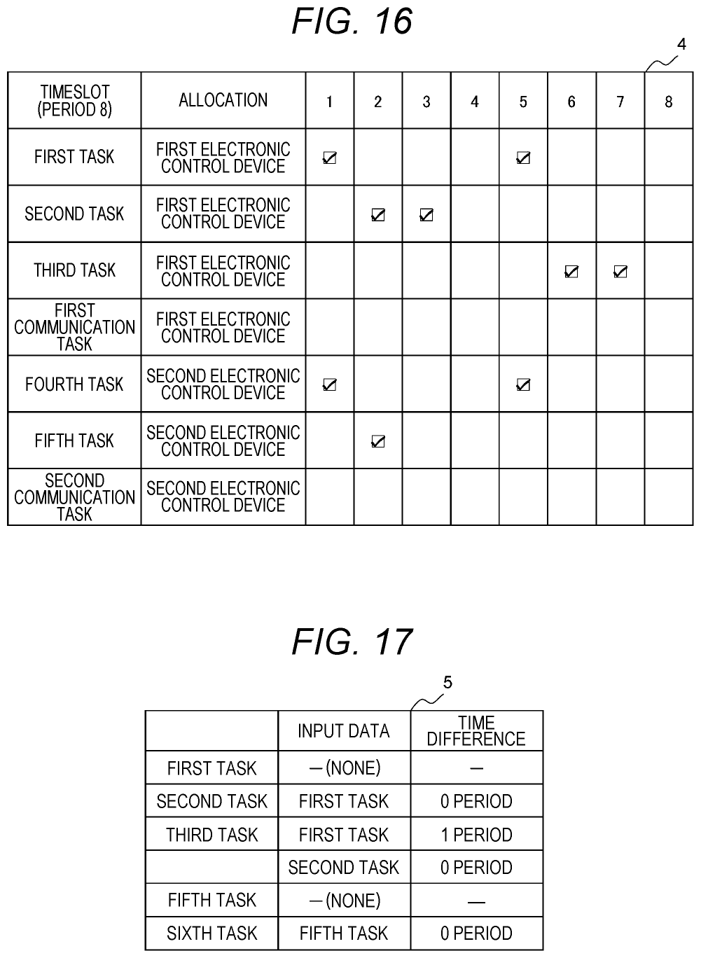

FIG. 16 is a diagram illustrating the timeslot allocation information 4 (before addition of a new task) stored in the timeslot allocation information storage unit 1015 constituting the middleware 101 of the first electronic control device 8 and the second electronic control device 9 of the present embodiment.

### <Timeslot Allocation Information 4>

As illustrated in FIG. 16, both the middleware of the first electronic control device 8 and the middleware 101 of the second electronic control device 9 store the timeslot allocation information 4 of the task mounted on each electronic control device. That is, the timeslot allocation information storage unit 1015 of the first electronic control device 8 holds not only the first task 102, the second task 103, the third task 104, and the first communication task 108 but also the timeslot allocation information 4 of the fifth task 106, the sixth task 107, and the second communication task 109 executed by the second electronic control device 9. Similarly, the second electronic control device 9 holds the timeslot allocation information 4 of a task executed by the first electronic control device 8 and a task executed by the second electronic control device 9. The timeslot allocation information 4 includes information for identifying an electronic control device to which each task is allocated.

FIG. 17 is a diagram illustrating the data flow request information 5 (before addition of a new task) stored in the data flow request information storage unit 1016 constituting the middleware 101 of the first electronic control device 8 and the second electronic control device 9 of the present embodiment.

### <Data Flow Request Information 5>

As illustrated in FIG. 17, both the middleware of the first electronic control device 8 and the middleware 101 of the second electronic control device 9 store the data flow request information 5 of the task mounted on each electronic control device. That is, the data flow request information storage unit 1016 of the first electronic control device 8 holds not only the first task 102, the second task 103, the third task 104, and the first communication task 108 but also the data flow request information 5 of the fifth task 106, the sixth task 107, and the second communication task 109 executed by the second electronic control device 9. Similarly, the second electronic control device 9 holds the data flow request information 5 of a task executed by the first electronic control device 8 and a task executed by the second electronic control device 9.

### <First Communication Task 108 and Second Communication Task 109 (Before Addition of New Task)>

The first communication task 108 and the second communication task 109 are tasks for communicating with the outside in the first electronic control device 8 and the second electronic control device 9. In the present embodiment, before the addition of the new task, according to the allocation of each task to the electronic control device illustrated in FIG. 16 and the data communication between the tasks illustrated in FIG. 17, there is no data communication between the first electronic control device 8 and the second electronic control device 9, so that the execution of the first communication task 108 and the second communication task 109 is unnecessary and is not allocated to any timeslot.

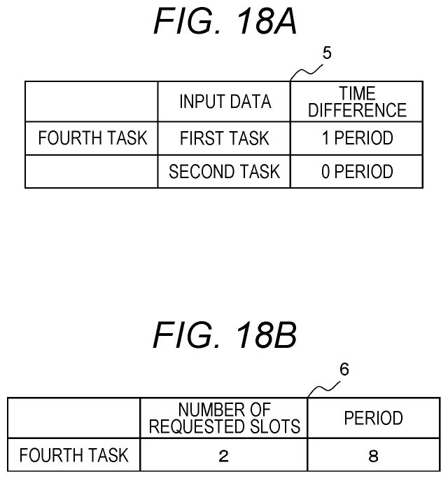

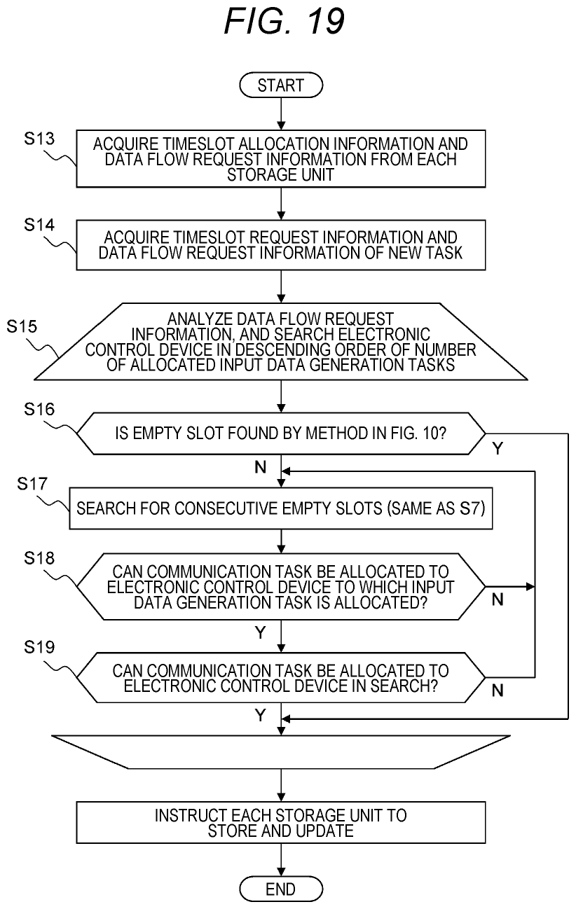

FIG. 18A is a diagram illustrating the data flow request information 5 related to the fourth task 105 which is a new task of the present embodiment, and FIG. 18B is a diagram illustrating the timeslot request information 6 related to the fourth task 105 which is a new task of the present embodiment.

### <New Task (Fourth Task 105)>

The fourth task 105 newly added in the present embodiment uses data generated by the first task 102 and the second task 103 and requests two timeslots.

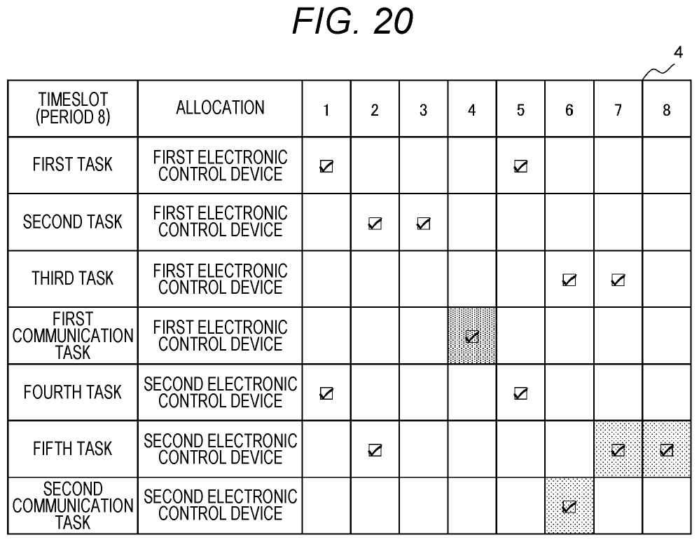

FIG. 19 is a flowchart of timeslot search processing by the timeslot allocation unit 1012 of the present embodiment. FIG. 20 is a diagram illustrating the timeslot allocation information 4 (after addition of a new task) stored in the timeslot allocation information storage unit 1015 constituting the middleware 101 of the first electronic control device 8 and the second electronic control device 9 of the present embodiment.

### <Timeslot Allocation Unit 1012>

The timeslot allocation unit 1012 mounted on the first electronic control device 8 searches s for an empty timeslot according to the algorithm of FIG. 19.

In step S13, the timeslot allocation information 4 stored in the timeslot allocation information storage unit 1015 and the data flow request information 5 stored in the data flow request information storage unit 1016 are acquired. In step S14, the data flow request information 5 and the timeslot request information 6 related to the new task (fourth task 105) are acquired. In the case of the present embodiment, it is necessary to select an electronic control device to which a new task (fourth task 105) is allocated. Therefore, in step S15, the data flow request information 5 of the new task (fourth task 105) is analyzed, and an empty slot is searched in order from the electronic control device to which the most tasks for generating the input data are allocated. For example, in the case of the present embodiment, the input data generation tasks of the fourth task 105 are the first task 102 and the second task 103, and these tasks are allocated to the first electronic control device 8 as illustrated in FIG. 16. Therefore, when the second electronic control device 9 is searched for after searching from the first electronic control device 8, an electronic control device having a small communication amount between the electronic control devices can be searched for by the search in step S15.

In step S16, the same algorithm as in steps S5 to S10 in FIG. 10 is applied to search for an empty slot. At this time, if an empty slot is found, a new task (fourth task 105) can be added similarly to the first embodiment, and thus the algorithm ends. In a case where all the input data generation tasks are allocated to the same electronic control device, the search ends in step S16. Therefore, in a case where the input data generation task is allocated to a plurality of electronic control devices, the search in step S16 may not be performed, and the search may be started from step S17. In the case of the present embodiment, since all the input data generation tasks are allocated to the same electronic control device, the search in step S16 is performed without being skipped. However, as illustrated in FIG. 16, there are no two consecutive empty timeslots in the first electronic control device 8. Therefore, in step S15, the search target is changed to the second electronic control device 9, and the process proceeds to step S17.

In step S17, consecutive empty slots in the second electronic control device 9 are searched. Referring to FIG. 16, the third and fourth timeslots and the sixth to eighth timeslots are consecutive empty slots. In step S18, it is determined whether the communication task can be allocated to the electronic control device to which the input data generation task is allocated. That is, it is determined whether the first communication task 108 can be allocated to the first electronic control device 8 for transmitting data from the first electronic control device 8 to the second electronic control device 9. According to the data flow request information 5, it is necessary to transmit data generated by the first task 102 and the second task 103 to the second electronic control device 9. In a case where the new task (fourth task 105) is allocated to the third and fourth timeslots of the second electronic control device 9, it can be seen that it is not in time for the timing of transmitting data from the first electronic control device 8. Therefore, the third and fourth empty slots cannot be used. In the sixth to eighth timeslots, the first communication task 108 can be allocated to the fourth timeslot of the first electronic control device 8.

Therefore, in step S18, the sixth to eighth timeslots of the second electronic control device 9 are selected. In step S19, it is confirmed whether a communication task (second communication task 109) for receiving data can be allocated to the second electronic control device 9 that is searching for an empty slot for allocating a new task (fourth task 105). In step S18, the first communication task 108 is allocated to the fourth timeslot of the first electronic control device 8, and the communication data is transmitted from the first electronic control device 8 in the fourth timeslot. Therefore, an empty timeslot after the fourth timeslot is suitable for the second communication task 109. Therefore, in the second electronic control device 9, the second communication task 109 is allocated to the sixth timeslot, which is the earliest empty timeslot after the fourth timeslot, and the new task (fourth task 105) is allocated to the remaining seventh and eighth timeslots.

As described above, as illustrated in FIG. 20, the timeslot allocation information 4 (after addition of a new task) is updated.

According to the present embodiment, it is possible to apply a system-level Logical Execution Time, which is a scheduling method for synchronizing time between electronic control devices and limiting the start and end of communication between tasks of the electronic control devices to predetermined timing by the arrangement of the communication tasks. In addition, it is possible to achieve the data flow defined in the data flow request information 5 after absorbing the fluctuation in the communication time between the electronic control devices, and particularly, it is possible to automatically determine an electronic control device to which a new task is to be allocated, and to allocate the new task to an appropriate timeslot.

### Fourth Embodiment

An electronic control device and a vehicle control system according to a fourth embodiment of the present invention will be described. The fourth embodiment is different from the first embodiment in that, in a case where no empty timeslot is found, the data flow request information 5 and the timeslot request information 6 of the new task are rejected. In the fourth embodiment, differences from the first embodiment will be mainly described, and the same components as those of the first embodiment are denoted by the same reference numerals, and description thereof will be omitted.

### <Timeslot Allocation Unit 1012, Timeslot Allocation Information Storage Unit 1015, and Data Flow Request Information Storage Unit 1016>

In a case where the search for an empty timeslot fails by the algorithm according to the first embodiment, the timeslot allocation unit 1012 rejects the request for adding the new task, does not change the timeslot, does not update the timeslot allocation information 4 stored in the timeslot allocation information storage unit 1015 and the data flow request information 5 stored in the data flow request information storage unit 1016, and does not add the new task (fourth task 105).

According to the present embodiment, it is possible to prevent destruction of a data flow related to an existing task due to addition of a new task.

### Fifth Embodiment

An electronic control device and a vehicle control system according to a fifth embodiment of the present invention will be described. The fifth embodiment is different from the first embodiment in that a use case is not addition of a new task but expansion and contraction of a processing time associated with a processing change related to an existing task. In the fifth embodiment, differences from the first embodiment will be mainly described, and the same components as those of the first embodiment are denoted by the same reference numerals, and description thereof will be omitted.

### <Timeslot Allocation Unit 1012, Timeslot Allocation Information Storage Unit 1015, and Data Flow Request Information Storage Unit 1016>

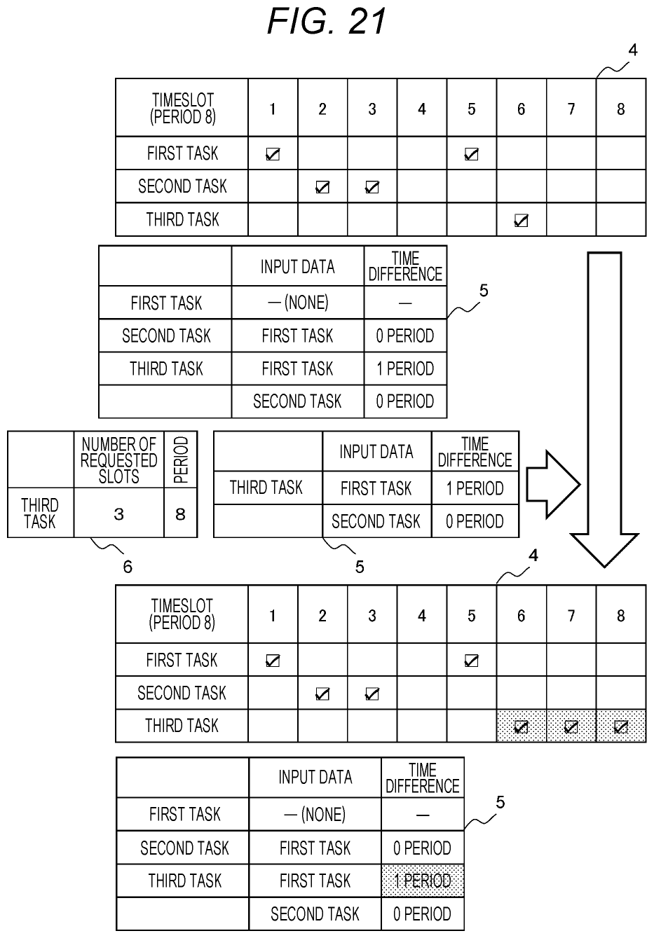

FIG. 21 is a diagram illustrating update of the timeslot allocation information 4 and the data flow request information 5 of the present embodiment.

In the algorithm of the first embodiment (FIG. 10), in a case where the data flow request information 5 and the timeslot request information 6 are related to an existing task (for example, the third task 104), the timeslot allocation unit 1012 refers to the timeslot allocation information 4 and updates the allocation information related to the existing task. In a case where the data flow request information 5 is the same as the information stored in the data flow request information storage unit 1016, the input of the data flow request information 5 to the timeslot allocation unit 1012 may be omitted.

According to the present embodiment, even in a case where the processing time of the existing task is increased or decreased by the Over-The-Air update, the allocation of the existing task to the timeslot can be updated without affecting other existing tasks, and the task accompanied by expansion and contraction can be updated.

### Sixth Embodiment

An electronic control device and a vehicle control system according to a sixth embodiment of the present invention will be described. The sixth embodiment is different from the first embodiment in that the use case is not addition of a new task but deletion of an existing task by changing the number of requested slots to zero. In the sixth embodiment, differences from the first embodiment will be mainly described, and the same components as those of the first embodiment are denoted by the same reference numerals, and description thereof will be omitted.

### <Timeslot Allocation Unit 1012, Timeslot Allocation Information Storage Unit 1015, and Data Flow Request Information Storage Unit 1016>

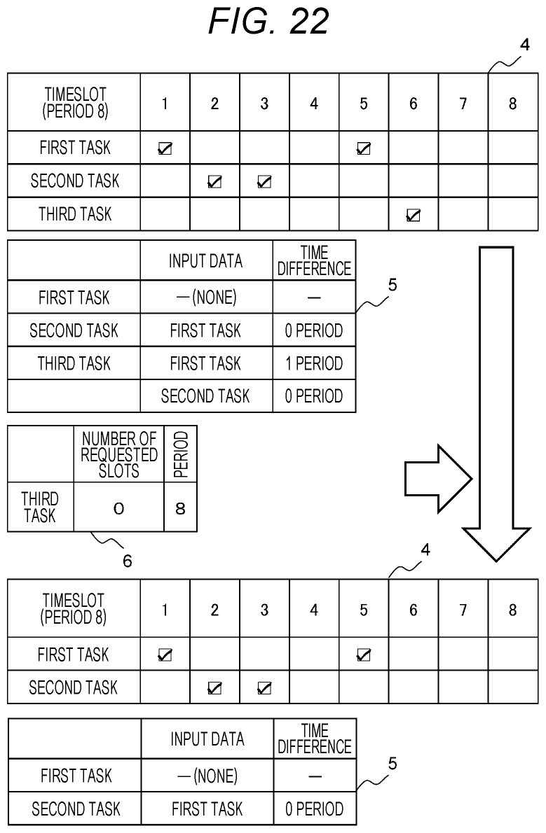

FIG. 22 is a diagram illustrating update of the timeslot allocation information 4 and the data flow request information 5 of the present embodiment.

In a case where the number of requested slots of the task included in the timeslot request information 6 is 0, the timeslot allocation unit 1012 deletes the task in which the number of requested slots is 0. In a case where the existing task is deleted, the data flow request information 5 may not be input to the timeslot allocation unit 1012. The timeslot allocation unit 1012 deletes the information related to the task to be deleted from the timeslot allocation information storage unit 1015 and the data flow request information storage unit 1016.

According to the present embodiment, an existing task can be deleted by the same processing as adding or correcting a task.

### Seventh Embodiment

An electronic control device and a vehicle control system according to a seventh embodiment of the present invention will be described. The seventh embodiment is different from the sixth embodiment in that a delete request for some tasks is rejected. In the seventh embodiment, differences from the first to sixth embodiments will be mainly described, and the same components as those in the first to sixth embodiments are denoted by the same reference numerals, and description thereof will be omitted.

### <Timeslot Allocation Unit 1012, Timeslot Allocation Information Storage Unit 1015, and Data Flow Request Information Storage Unit 1016>

In a case where the number of requested slots included in the timeslot request information 6 is 0, the timeslot allocation unit 1012 attempts to delete the task. At the time of task deletion, the data flow request information 5 stored in the data flow request information storage unit 1016 is analyzed, and in a case where the task to be deleted is not an input data generation task of another task, that is, the task to be deleted is not recorded in the column of “input data” of the data flow request information 5, the delete request is received, and the task is deleted as in the sixth embodiment. On the other hand, in a case where the task to be deleted is an input data generation task of another task, similarly to the fourth embodiment, the request is rejected and the stored information is not updated.

According to the present embodiment, it is possible to prevent destruction of a data flow related to another task due to deletion of an existing task.

### Eighth Embodiment

An electronic control device and a vehicle control system according to an eighth embodiment of the present invention will be described. The eighth embodiment is different from the first embodiment in that a server that executes timeslot allocation processing is provided and the timeslot allocation information 4 is provided to a plurality of electronic control devices. In the eighth embodiment, differences from the first embodiment will be mainly described, and the same components as those of the first embodiment are denoted by the same reference numerals, and description thereof will be omitted.

### <Hardware Configuration of Vehicle Control System 12>

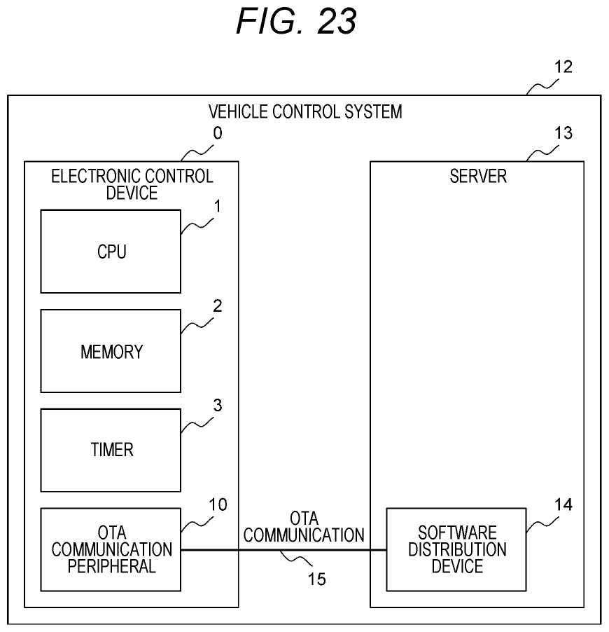

FIG. 23 is a diagram illustrating a hardware configuration of a vehicle control system 12 according to the present embodiment.

The vehicle control system 12 includes an electronic control device 0 and a server 13. The electronic control device 0 includes a CPU 1, a memory 2, a timer 3, and an OTA communication peripheral 7 for performing OTA communication 15 with the server 13. The server 13 includes a software distribution device 14 for performing the OTA communication 15 with the electronic control device 0. The OTA communication 15, the OTA communication peripheral 7, and the software distribution device 14 may be in accordance with a known technology of the Over-The-Air that enables wireless software update.

### <Software Configuration of Vehicle Control System 12>

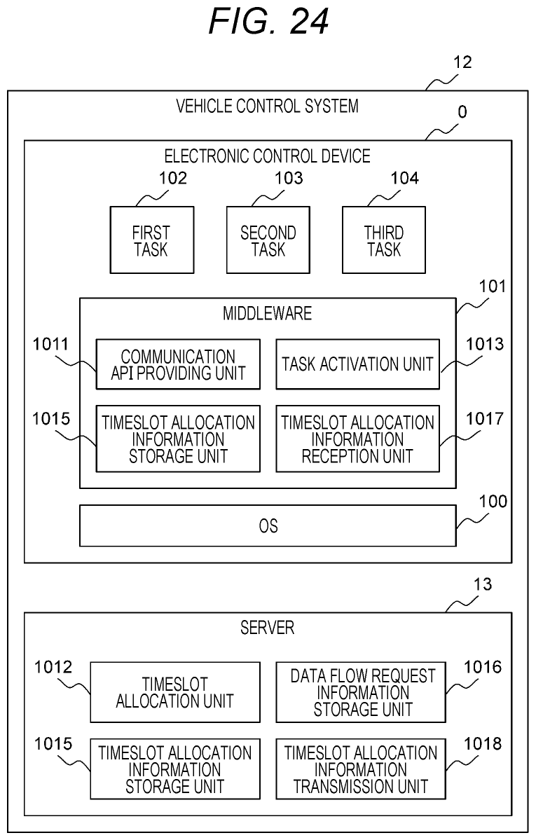

FIG. 24 is a diagram illustrating a software configuration of the vehicle control system 12 according to the present embodiment.

The electronic control device 0 includes an OS 100, middleware 101, a first task 102, a second task 103, and a third task 104. The middleware 101 includes a communication API providing unit 1011, a task activation unit 1013, a timeslot allocation information storage unit 1015, and a timeslot allocation information reception unit 1017. The server 13 includes a timeslot allocation unit 1012, a timeslot allocation information storage unit 1015, a data flow request information storage unit 1016, and a timeslot allocation information transmission unit 1018. The timeslot allocation information 4 stored in the timeslot allocation information storage unit 1015 included in the middleware 101 of the electronic control device 0 includes information of timeslot allocation related to a task executed by the electronic control device 0 itself. The timeslot allocation information 4 stored in the timeslot allocation information storage unit 1015 included in the server 13 includes information of timeslot allocation related to a task executed by a part or all of the electronic control devices to which the server 13 performs communication and OTA distribution is performed. The timeslot allocation information reception unit 1017 has a function of receiving the timeslot allocation information 4 from the server 13 using the OTA communication peripheral 7. The timeslot allocation information transmission unit 1018 has a function of transmitting the timeslot allocation information 4 to the electronic control device 0 using the software distribution device 14.

According to the present embodiment, by executing the timeslot allocation processing in the server 13, the timeslot allocation information 4 can be provided to the plurality of electronic control devices 0, and the processing load of the middleware 101 included in the electronic control device can be reduced.

### Ninth Embodiment

An electronic control device and a vehicle control system according to a ninth embodiment of the present invention will be described. A difference between the ninth embodiment and the eighth embodiment is that a server is provided with a function of providing information for avoiding rejection when addition of a new task, deletion of an existing task, or change in the number of requested timeslots of an existing task is rejected. In the ninth embodiment, differences from the first to eighth embodiments will be mainly described, and the same components as those in the first to eighth embodiments are denoted by the same reference numerals, and description thereof will be omitted.

### <Software Configuration of Vehicle Control System 12>

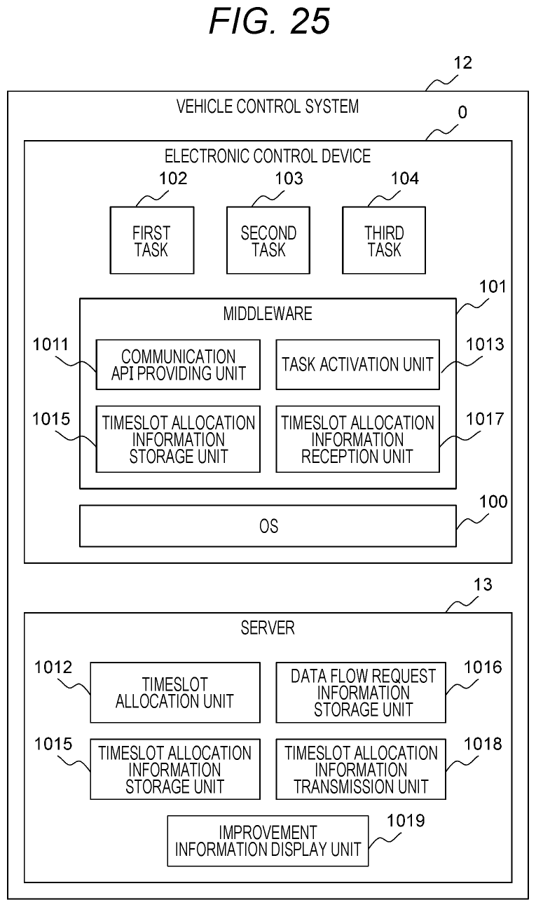

FIG. 25 is a diagram illustrating a software configuration of the vehicle control system 12 according to the present embodiment.

The server 13 includes a timeslot allocation unit 1012, a timeslot allocation information storage unit 1015, a data flow request information storage unit 1016, a timeslot allocation information transmission unit 1018, and an improvement information display unit 1019.

### <Improvement Information Display Unit 1019>

The improvement information display unit 1019 provides information for avoiding rejection when determining to reject addition of a new task, deletion of an existing task, or a change in the number of requested timeslots of an existing task. Specifically, in a case where the addition of the new task and the change in the number of requested timeslots of the existing task are rejected, the maximum value of the number of empty timeslots that can be allocated based on the data flow request information 5 is indicated, and in a case where the deletion of the existing task is rejected, the task that needs to be simultaneously (or first) deleted from the data flow request information 5 is indicated.

According to the present embodiment, it is possible to provide information regarding timing design to a designer and a vehicle user.

Further, the present invention is not limited to the above-described embodiments. Various modifications and equivalent configurations may be contained within the scope of claims. For example, the above-described embodiments are given in detail in order to help easy understating of the present invention. The present invention is not limited to providing all the configurations described above. In addition, some of the configurations of a certain embodiment may be replaced with the configuration of the other embodiment. In addition, the configurations of the other embodiment may be added to the configurations of a certain embodiment. In addition, some of the configurations of each embodiment may be added, omitted, or replaced with respect to the configuration of the other embodiment.

In addition, the above-described configurations, functions, processing units, and processing means may be realized by a hardware configuration by setting some or all of the configurations using an integrated circuit, or may be realized by a software configuration by analyzing and performing a program to realize the functions by the processor.

The information of the program realizing functions, tables, and files may be stored in a memory device such as a memory, a hard disk, a Solid State Drive (SSD) or a recording medium such as an IC card, an SD card, and a DVD.

In addition, only control lines and information lines considered to be necessary for explanation are illustrated, but not all the control lines and the information lines necessary for mounting are illustrated. In practice, almost all the configurations may be considered to be connected to each other.

1. An electronic control device comprising:
an arithmetic device that performs predetermined arithmetic processing and periodically executes a task; and a memory device that can be accessed by the arithmetic device, wherein
timings of data input and data output of the task are determined in advance,
the electronic control device comprises:
a timeslot allocation information storage unit that stores timeslot allocation information defining an execution timing of the task between the predetermined data input timing and data output timing;
a task activation unit that activates the task according to the timeslot allocation information; and
a timeslot allocation unit that stores information of a new task in the timeslot allocation information storage unit according to an execution timing of the new task, and
the timeslot allocation unit is configured to execute:
receiving an input of data flow request information and timeslot request information, the data flow request information including information on a task for generating data to be input to the new task and information on how many periods before a timeslot for activating the new task to use the data generated by the task and the timeslot request information including information on a number of timeslots necessary for executing the new task;
searching for an empty timeslot in which the new task is executed based on the timeslot allocation information, the data flow request information, and the timeslot request information; and
updating the timeslot allocation information so as to allocate the new task to the searched empty timeslot.

2. The electronic control device according to claim 1, wherein
the timeslot allocation unit allocates the new task to the searched empty timeslot so as to shorten a latency of the new task, and updates the timeslot allocation information.

3. The electronic control device according to claim 1, wherein
the timeslot allocation unit is configured to execute:
referring, in a case where a search for an empty timeslot that satisfies both the data flow request information and the timeslot request information related to the new task fails, to the data flow request information and the timeslot allocation information, changing a timeslot allocated to an existing task so as to satisfy a data flow request of the existing task to generate an empty timeslot; and
updating the timeslot allocation information so as to allocate execution of the new task to the generated empty timeslot.

4. The electronic control device according to claim 1, wherein
time is synchronized with time of another electronic control device that executes the task;
timings of input and output of each task are determined in advance based on the synchronized time, and
in a case where data communication with the another electronic control device is required based on the data flow request information, the timeslot allocation information includes a predetermined data communication timing between the tasks.

5. The electronic control device according to claim 1, wherein
the timeslot allocation unit rejects a request for adding the new task and does not update the data flow request information and the timeslot allocation information in a case where a search for an empty timeslot that satisfies both the data flow request information and the timeslot request information related to the new task fails.

6. The electronic control device according to claim 1, wherein
the timeslot allocation unit is configured to execute:
searching for an empty timeslot for executing an existing task whose processing time is changed based on the timeslot allocation information, the data flow request information, and the timeslot request information in a case where the processing time of the existing task increases or decreases; and
updating the timeslot allocation information so as to allocate the existing task to the searched empty timeslot.

7. The electronic control device according to claim 1, wherein
the timeslot allocation unit is configured to execute
deleting information of an existing task related to a delete request from the data flow request information and the timeslot allocation information according to the delete request of the existing task.

8. The electronic control device according to claim 7, wherein
the timeslot allocation unit is configured to execute:
analyzing the data flow request information; and
rejecting the delete request, and not updating the data flow request information and the timeslot allocation information in a case where the existing task related to the deleting generates another input data of the task.

9. A vehicle control system comprising:
the electronic control device according to claim 1; and
a server capable of communicating with the electronic control device, wherein
the server is configured to execute:
saving timeslot allocation information and data flow request information;
searching for an empty timeslot according to a request for a timeslot based on the timeslot allocation information and the data flow request information; and
updating the timeslot allocation information so as to allocate a task according to the request to the searched empty timeslot;
transmitting the updated timeslot allocation information to the electronic control device, and
the electronic control device updates, with timeslot allocation information received from the server, timeslot allocation information stored in the electronic control device.

10. The vehicle control system according to claim 9, wherein
as a result of the searching for the timeslots, the server includes an improvement information display unit that presents information regarding rejection of a request for a change in a number of timeslots of the task, and
the information related to the rejection includes at least one of a maximum value of a number of empty timeslots satisfying the data flow request information and information of an existing task that generates input data.

11. A method for controlling a task executed by an electronic control device, wherein
the electronic control device includes an arithmetic device that performs predetermined arithmetic processing and periodically executes a task, and a memory device that can be accessed by the arithmetic device,
timings of data input and data output of the task are determined in advance,
the memory device stores timeslot allocation information that defines an execution timing of the task between the predetermined data input timing and data output timing,
the method comprises:
a task activation process of activating, by the arithmetic device, the task according to the timeslot allocation information; and
a timeslot allocation process of storing, by the arithmetic device, information of a new task according to an execution timing of the new task, and
in the timeslot allocation process,
the arithmetic device receives an input of data flow request information and timeslot request information, the data flow request information including information on a task that generates data to be input to the new task and information on how many periods before a timeslot activating the new task to use the data generated by the task and the timeslot request information including information on a number of timeslots necessary for executing the new task
the arithmetic device searches for an empty timeslot in which the new task is executed based on the timeslot allocation information, the data flow request information, and the timeslot request information, and
the arithmetic device updates the timeslot allocation information so as to allocate the new task to the searched empty timeslot.

12. The method for controlling a task according to claim 11, wherein
in the timeslot allocation process, the arithmetic device allocates the new task to the searched empty timeslot so as to shorten a latency of the new task, and updates the timeslot allocation information.
